(19) United States
(12) Patent Application Publication
(10) Pub. No.: US 2009/0082940 A1
(43) Pub. Date: Mar. 26, 2009

(54) INTERNAL COMBUSTION ENGINE CONTROL DEVICE

(75) Inventors: Koji ISHIZUKA, Chita-gun (JP); Kenichiro Nakata, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/210,409

(22) Filed: Sep. 15, 2008

(30) Foreign Application Priority Data
Sep. 24, 2007 (JP) 2007-246342

(51) Int. Cl. F02D 41/30

(52) U.S. Cl. 701/103

(57) ABSTRACT

A control device of an internal combustion engine calculates a rotation increase amount caused in connection with a small injection based on a sensing value of a crank angle sensor and calculates an actual torque increase amount based on the calculated rotation increase amount. The control device senses fuel pressure fluctuation caused in connection with the small injection with a pressure sensor and calculates an actual injection quantity based on the sensed fuel pressure fluctuation. Then, the control device calculates a combustion rate by comparing the actual torque increase amount and the actual injection quantity and changes data (an injection pattern) of an injection control map in accordance with the combustion rate to achieve desired output torque and emission state.

### CROSS REFERENCE TO RELATED APPLICATION

This application is based on and incorporates herein by reference Japanese Patent Application No. 2007-246342 filed on Sep. 24, 2007.

### BACKGROUND OF THE INVENTION

1. Field of the Invention

The present invention relates to an internal combustion engine control device that controls an operation state of an internal combustion engine by controlling operation of an injector and the like.

2. Description of Related Art

Concerning control of a diesel engine (an internal combustion engine), multi-stage injection control for performing multiple times of injection during a combustion cycle is described in Patent document 1 (JP-A-2005-155360), for example. Conventionally, the optimum injection mode of multi-stage injection (such as the number of injection stages in the multi-stage injection, an injection quantity and injection timing of each stage of injection, and the like) is stored in the form of a map by using request torque (for example, an accelerator operation amount), engine rotation speed and the like as parameters.

The optimum injection mode is decided by using the map based on the above-described various parameters and the operation of the injector is controlled to achieve the decided optimum injection mode. Conventionally, the injector is controlled in the optimum injection mode in this way to obtain desired output torque and to achieve a desired emission state.

A rate (a combustion rate), at which the actually injected fuel contributes to combustion, changes with various conditions such as a fuel property (for example, the cetane number). Even if the injection stage number, the injection quantity and the injection timing of each injection stage and the like are the same, the obtained output torque and the emission state will vary if the combustion rate varies. For example, when the actual combustion rate is 50% although the map is created on the assumption that the combustion rate is 80%, a behavior of a heat release amount per unit time (i.e., a heat release rate) or a behavior of cylinder pressure (a behavior shown by a broken line in part (b) of FIG. 9) will deviate from a desired behavior (a behavior shown by a solid line in part (b) of FIG. 9). Eventually, decrease of the output torque and deterioration of the emission state can be induced, As described above, there has been a limit to accuracy of control of the output torque and the emission state by the conventional fuel injection control. Such the problem resulting from the combustion rate can occur not only in the case of the multi-stage injection but also in a single-stage injection similarly. Moreover the above-described problem resulting from the difference in the combustion rate can occur not only in the fuel injection control but also in other control for controlling the operation state of the internal combustion engine (for example, supercharging pressure control, EGR quantity control and the like) similarly.

### SUMMARY OF THE INVENTION

It is an object of the present invention to provide an internal combustion engine control device aiming to control output torque and an emission state with high accuracy.

According to a first example aspect of the present invention, a control device of an internal combustion engine includes a torque increasing section, a torque increase amount sensing section, an injection quantity sensing section, a combustion rate calculating section, and a controlling section. The torque increasing section performs fuel injection by operating an injector of the internal combustion engine, thereby increasing output torque of the internal combustion engine. The torque increase amount sensing section senses an increase amount of the output torque caused in connection with the fuel injection or a physical quantity relevant to the increase amount. The injection quantity sensing section senses an actual injection quantity of the fuel injection or a physical quantity relevant to the injection quantity. The combustion rate calculating section calculates a combustion rate based on a sensing value of the torque increase amount sensing section and a sensing value of the injection quantity sensing section. The combustion rate indicates a rate at which the fuel injected through the fuel injection contributes to combustion. The controlling section controls an operation state of the internal combustion engine in accordance with the combustion rate calculated by the combustion rate calculating section.

That is, according to the first example aspect of the present invention, output torque is increased through the fuel injection performed by the torque increasing section, and the torque increase amount, the injection quantity and the like at the time are sensed. The combustion rate is calculated based on the sensed values. For example, the combustion rate can be calculated by calculating a deficiency of the actually sensed torque increase amount with respect to an estimated torque increase amount that is estimated on an assumption that 100% of the sensed injection quantity contributes to the combustion. According to the first example aspect of the present invention, the operation state of the internal combustion engine is controlled in accordance with the combustion rate calculated in this way. Accordingly, the output torque and the emission state of the internal combustion can be controlled with high accuracy.

The torque increasing section described above should preferably perform the fuel injection to increase the output torque when a no-injection execution condition for cutting the fuel injection from the injector is satisfied (for example, when an accelerator operation is not performed by a driver). With such the construction, the fuel injection by the torque increasing section is performed in a state where little or no fluctuation of the output torque is caused. Accordingly, the torque increase amount sensing section can sense the output torque increase amount with high sensing accuracy. Therefore, the increase amount of the output torque caused in connection with the fuel injection performed by the torque increasing section can be sensed with high accuracy.

Furthermore, it is preferable that the fuel injection performed by the torque increasing section is a small injection (for example, an injection of approximately 2 mm³/st) explained below. That is, the fuel injection performed by the torque increasing section should be preferably an injection of a quantity small to such an extent that the driver of the internal combustion engine (e.g., a driver of a vehicle mounted with the internal combustion engine) does not feel the torque increase when the torque increasing section increases the output torque. Moreover, in the case where a diesel engine is adopted as the internal combustion engine and the injector can perform multi-stage injection for performing the injection multiple times per combustion cycle, it is preferable that the fuel injection is performed with a smaller quantity (for example, a quantity corresponding to a pilot injection or a pre-injection) than a quantity of a main injection in the multi-stage injection. Thus, an increasing degree of the engine rotation speed against an intention of the driver of the internal combustion engine can be reduced during the above-described no-injection period.

According to a second example aspect of the present invention, a fuel supply system of the internal combustion engine is structured such that the fuel is distributed and supplied from a pressure accumulator, which accumulates the fuel, to the injector. The injection quantity sensing section is a fuel pressure sensor that senses pressure of the fuel supplied to the injector as the physical quantity and that is located in a fuel passage extending from the pressure accumulator to an injection hole of the injector at a position closer to the injection hole than the pressure accumulator.

The pressure of the fuel supplied to the injector fluctuates in connection with the fuel injection from the injection hole. Therefore, by sensing the fluctuation mode (e.g., a fuel pressure decrease amount, a fuel pressure decrease time, and the like), the actual injection quantity can be calculated. According to the second example aspect of the present invention paying attention to this point, the fuel pressure sensor that senses the pressure of the fuel supplied to the injector as the physical quantity relevant to the injection quantity is adopted as the injection quantity sensing section. Accordingly, the injection quantity can be calculated as described above.

Moreover, according to the second example aspect of the present invention, the fuel pressure sensor is arranged in the fuel passage extending from the pressure accumulator to the injection hole at a position closer to the injection hole than the pressure accumulator. Accordingly, the pressure fluctuation in the injection hole can be sensed before the pressure fluctuation attenuates inside the pressure accumulator. Therefore, the pressure fluctuation caused with the injection can be sensed with high accuracy, so the injection quantity can be calculated with high accuracy.

When the fuel injection performed by the torque increasing section is the small injection described above, the fluctuation of the fuel pressure caused in connection with the small injection is very small. Therefore, it is difficult to sense such the fluctuation of the fuel pressure with a fuel pressure sensor (a rail pressure sensor) arranged to the pressure accumulator. Therefore, by applying the second example aspect of the present invention to the case of the small injection that makes the sensing difficult, the above-described effect of enabling the highly accurate sensing of the pressure fluctuation can be suitably exerted.

As other application example than adopting the fuel pressure sensor as the injection quantity sensing section, a lift sensor that senses a lift amount of a valve member of the injector as a physical quantity relevant to the injection quantity, a flow meter arranged in a fuel supply passage extending to the injection hole for sensing a fuel flow rate as the injection quantity or the like may be adopted as the injection quantity sensing section.

According to a third example aspect of the present invention, the torque increase amount sensing section is a rotation speed sensor that senses rotation speed of an output shaft of the internal combustion engine (i.e., engine rotation speed) as the physical quantity. If the torque increases, the rotation speed of the output shaft also increases in accordance with the increase amount of the torque. Therefore, according to the third example aspect of the present invention that adopts the rotation speed sensor as the torque increase amount sensing section, the increase amount of the output torque can be suitably calculated.

As other application example than adopting the rotation speed sensor as the torque increase amount sensing section, a cylinder pressure sensor for sensing pressure in a combustion chamber of the internal combustion engine as a physical quantity relevant to the torque increase amount or the like may be adopted as the torque increase amount sensing section.

According to a fourth example aspect of the present invention, the controlling section is an injection controlling section for controlling an operation of the injector to change an injection mode of the fuel in accordance with the combustion rate. Accordingly, the injection mode can be controlled in consideration of the combustion rate to inhibit the behavior of the cylinder pressure (or the behavior of the heat release rate) from deviating from the desired behavior. Accordingly, the output torque and the emission state of the internal combustion can be controlled with high accuracy.

As other application example than adopting the injection controlling section as the controlling section, the controlling section may be adopted to perform supercharging pressure control for changing supercharging pressure in accordance with the combustion rate, EGR quantity control for changing an EGR quantity (an exhaust gas recirculation quantity: a quantity of part of exhaust gas recirculated to an intake air) in accordance with the combustion rate, or the like.

According to a fifth example aspect of the present invention, the injection controlling section is configured to be able to execute control of multi-stage injection for injecting the fuel multiple times during one combustion cycle, and the injection controlling section changes the injection mode by changing at least one of the number of injection stages in the multi-stage injection, an injection quantity of each injection stage of the multi-stage injection, and injection timing of each injection stage of the multi-stage injection. Thus, by changing at least one of the number of the injection stages of the multi-stage injection, the injection quantity of each injection stage and the injection timing of each injection stage in accordance with the combustion rate, the injection mode can be suitably controlled to inhibit the behavior of the cylinder pressure (or the behavior of the heat release rate) from deviating from the desired behavior.

The injection quantity of the pilot injection greatly affects the combustion state of the fuel injected through the main injection (for example, the combustion rate, the ignition timing, and the like). Eventually, the injection quantity of the pilot injection greatly affects the output torque acquired per combustion cycle and the emission state.

In view of this point, according to a sixth example aspect of the present invention, the injection controlling section changes the injection mode to change the injection quantity of the pilot injection in the multi-stage injection in accordance with the combustion rate. Therefore, the output torque and the emission state can be adjusted to the desired states by adjusting the pilot injection quantity.

As an example of the adjustment of the pilot injection quantity, adjustment may be performed to increase the pilot injection quantity as the combustion rate calculated by the combustion rate calculating section decreases.

Thus, ignitability of the fuel injected through the pilot injection or a pre-injection (an injection preceding the main injection) can be improved. Alternatively, adjustment may be performed to decrease the pilot injection quantity as the combustion rate increases. Thus, the emission (for example, HC and CO) can be reduced.

If the pilot injection quantity is increased or decreased as described above, there is a concern that a total quantity of the fuel injected per combustion cycle also increases or decreases and as a result the torque acquired per combustion cycle increases or decreases.

In this regard, according to a seventh example aspect of the present invention, the injection controlling section changes the injection mode to decrease the injection quantity of the main injection when the injection controlling section increases the injection quantity of the pilot injection. The injection controlling section changes the injection mode to increase the injection quantity of the main injection when the injection controlling section decreases the injection quantity of the pilot injection. Thus, the increase/decrease adjustment of the pilot injection quantity is performed to adjust the ignitability and the emission while performing the adjustment to prevent the increase/decrease in the total quantity of the fuel injected per combustion cycle. Thus, the adjustment can be performed while preventing the increase/decrease in the torque acquired per combustion cycle.

According to an eighth example aspect of the present invention, the injection controlling section changes the injection mode to change injection timing of the main injection in the multi-stage injection in accordance with the combustion rate. For example, when the combustion rate is low, there is a concern that timing when the cylinder pressure (or the heat release rate) reaches a peak or ignition timing of the main injection delays from desired timing. Therefore, it is preferable to perform advancing adjustment of the main injection timing when the combustion rate is low. When the combustion rate is high, it is preferable to perform adjustment for delaying the main injection timing to prevent the peak timing or the ignition timing from advancing from the desired timing.

It is preferable to apply the eighth example aspect of the present invention to the sixth example aspect of the present invention. That is, when the combustion rate is low, the pilot injection quantity is increased as in the sixth example aspect of the present invention to inhibit the delay of the peak timing of the cylinder pressure (or the heat release rate) or the ignition timing of the main injection. When the combustion rate is low to such an extent that the state cannot be handled only with the pilot injection quantity, it is preferable to advance the main injection timing as in the eighth example aspect of the present invention in addition to the increase of the pilot injection quantity to further inhibit the delay of the peak timing or the ignition timing described above.

According to a ninth example aspect of the present invention, the torque increasing section executes the fuel injection multiple times under the same condition. The combustion rate calculating section performs integral averaging of multiple calculation results of the combustion rate obtained through the multiple times of the fuel injection. The controlling section controls the operation state of the internal combustion engine in accordance with a combustion rate obtained through the integral averaging. According to the construction, influence due to the sensing error of the torque increase amount sensing section and the injection quantity sensing section and the like can be reduced as compared with the calculation result of the combustion rate obtained through a single fuel injection. As a result, an accurate value of the combustion rate containing little influence of the sensing error can be obtained.

According to a tenth example aspect of the present invention, the controlling section employs at least one of pressure of the fuel supplied to the injector, rotation speed of an output shaft of the internal combustion engine and the number of a cylinder of the internal combustion engine as a parameter or parameters and stores the combustion rate in relation to each parameter. The controlling section controls the operation state of the internal combustion engine in accordance with the combustion rate corresponding to each parameter. Since the combustion rate varies with each of the above-described parameters, according to the tenth example aspect of the present invention that controls the operation state of the internal combustion engine in accordance with the combustion rate corresponding to each parameter the output torque and the emission state of the internal combustion engine can be controlled with higher accuracy.

Even if the conditions such as the injection mode and the above-described parameters are the same, the combustion rate will increase if the cetane number of the fuel is high and the combustion rate will decrease if the cetane number is low. In view of this point, according to an eleventh example aspect of the present invention, the control device further includes a cetane number estimating section for estimating a cetane number of the fuel based on the combustion rate calculated by the combustion rate calculating section.

Therefore, the cetane number can be estimated using the combustion rate calculated for the use in the controlling section.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a schematic diagram showing an engine control system having a fuel injection control device according to an embodiment of the present invention;

FIG. 2 is a longitudinal cross-sectional diagram showing an internal structure of an injector according to the embodiment;

FIG. 3 is a flowchart showing a basic processing procedure of fuel injection control processing according to the embodiment;

FIG. 4 is an injection control map according to the embodiment;

FIG. 5 is a flowchart showing a processing procedure for learning the injection control map of FIG. 4 according to the embodiment;

FIG. 6 is a timing chart showing changes of rotation speed and output torque at the time when a small injection is performed in learning processing according to the embodiment;

FIG. 7 is a timing chart showing changes of a sensing value of a pressure sensor and an injection rate at the time when the small injection is performed in the learning processing according to the embodiment;

FIG. 8 is a diagram showing a relationship between the output torque and an injection quantity used in the learning processing according to the embodiment; and

FIG. 9 is a timing chart showing the injection rate and variation in cylinder pressure due to variation in a combustion rate.

### DETAILED DESCRIPTION OF EXAMPLE EMBODIMENT

Hereinafter, a fuel injection device and a fuel injection system according to an embodiment of the present invention will be described with reference to the drawings. The device according to the present embodiment is mounted, for example, in a common rail fuel injection system for an engine (an internal combustion engine) for a four-wheeled automobile. The device according to the present embodiment is used when performing injection supply (direct injection supply) of high-pressure fuel (for example, light oil at injection pressure of 1000 atmospheres or higher) directly into a combustion chamber in an engine cylinder of a diesel engine.

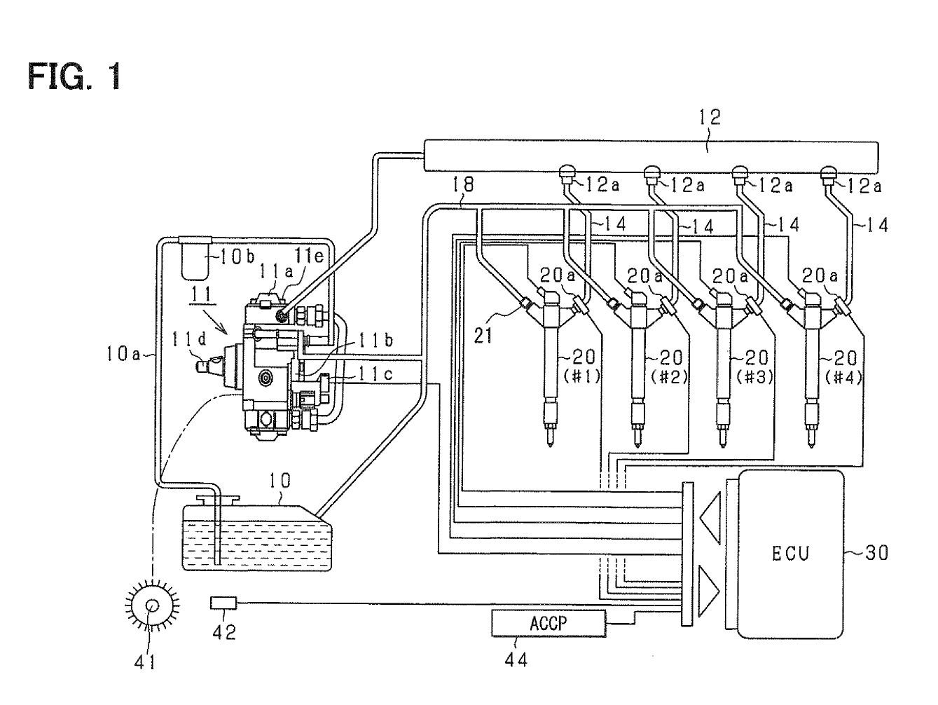

First, with reference to FIG. 1, an outline of the common rail fuel injection system (an in-vehicle engine system) according to the present embodiment will be explained. It is assumed that the engine according to the present embodiment is a four-stroke reciprocating diesel engine (an internal combustion engine) having multiple cylinders (for example, in-line four cylinders). In the engine, the cylinder as a target cylinder at the time is sequentially distinguished by a cylinder determination sensor (an electromagnetic pickup) provided to a camshaft of a suction valve or an exhaust valve. In each of the four cylinders #1-#4, a combustion cycle consisting of four strokes of an intake stroke, a compression stroke, a combustion stroke, and an exhaustion stroke is sequentially performed in the order of the cylinders #1, #3, #4, and #2 in a cycle of 720° C.A, more specifically, while the combustion cycles are deviated from each other by 180° C.A between the cylinders.

As shown in FIG. 1, generally, the system is structured such that an ECU 30 as an electronic control unit (a fuel injection controlling section) takes in sensor outputs (sensing results) from various sensors and controls drive of respective components constituting a fuel supply system based on the respective sensor outputs. The ECU 30 adjusts a current supply quantity to a suction control valve 11c, thereby controlling a fuel discharge quantity of a fuel pump 11 to a desired value. Thus, the ECU 30 performs feedback control (for example, PID control) for conforming fuel pressure in a common rail 12 (a pressure accumulator), i.e., current fuel pressure measured with a fuel pressure sensor 20a, to a target value (target fuel pressure). The ECU 30 controls a fuel injection quantity injected to a predetermined cylinder of the target engine and eventually an output of the engine (i.e., rotation speed or torque of an output shaft) of the target engine to desired magnitudes.

The devices constituting the fuel supply system including the fuel tank 10, the fuel pump 11, the common rail 12, and the injectors 20 (fuel injection valves) are arranged in this order from a fuel flow upstream side. Among the devices, the fuel tank 10 and the fuel pump 11 are connected by a pipe 10a via a fuel filter 10b.

The fuel pump 11 consists of a high-pressure pump 11a and a low-pressure pump 11b driven by a drive shaft 11d. The fuel pump 11 is structured such that fuel drawn by the low-pressure pump 11b from the fuel tank 10 is pressurized and discharged by the high-pressure pump 12a. A fuel pumping quantity sent to the high-pressure pump 11a and an eventual fuel discharge quantity of the fuel pump 11 are metered by the suction control valve 11c (SCV) provided on a suction side of the fuel pump 11. The fuel pump 11 can control the fuel discharge quantity from the pump 11 to a desired value by regulating drive current (eventually, a valve opening degree) of the suction control valve 11c to a desired value. For example, the suction control valve 11c is a normally-on type regulating valve that opens when de-energized.

The fuel drawn by the fuel pump 11 from the fuel tank 10 through the fuel filter 10b is pressure-fed (pumped) to the common rail 12. The common rail 12 accumulates the fuel pumped from the fuel pump 11 in a high-pressure state. The fuel accumulated in the high-pressure state in the common rail 12 is distributed and supplied to the injectors 20 of the respective cylinders #1-#4 through high-pressure pipes 14 provided to the respective cylinders. Fuel discharge holes 21 of the injectors 20(#1)-20(#4) are connected with a pipe 18 for returning excess fuel to the fuel tank 10. An orifice 12a (a fuel pulsation reducing device) is provided between the common rail 12 and the high-pressure pipe 14 for attenuating a pressure pulsation of the fuel flowing from the common rail 12 to the high-pressure pipe 14.

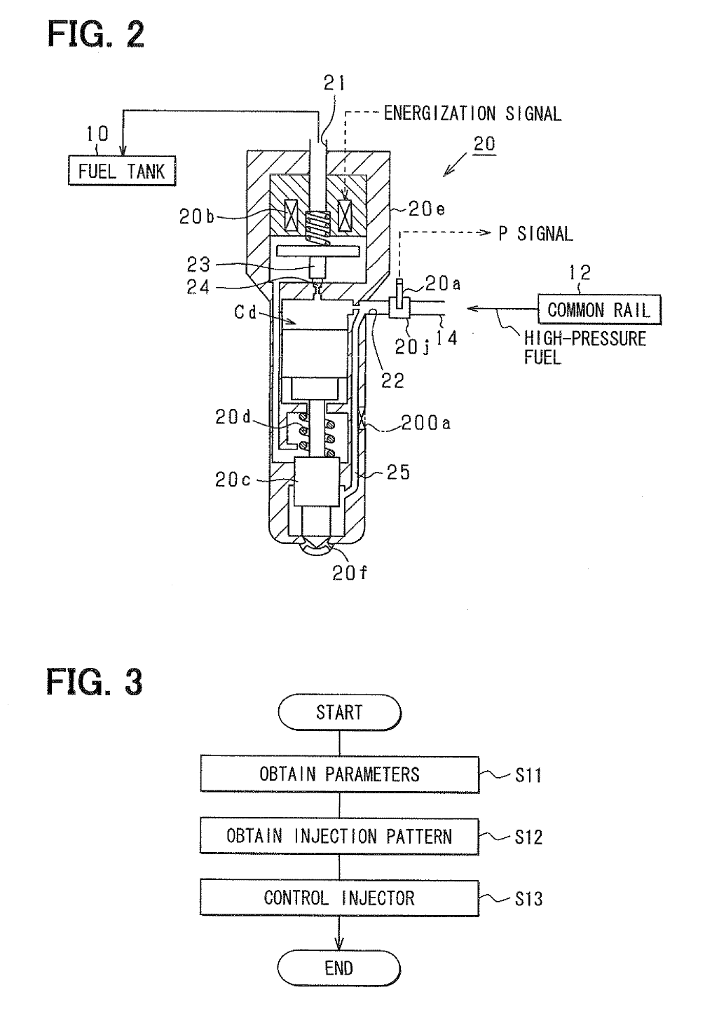

A detailed structure of the injector 20 is shown in FIG. 2. Basically, the four injectors 20(#1)-20(#4) have the same structure (for example, a structure shown in FIG. 2). Each injector 20 is a hydraulic drive type injector using the engine combustion fuel (i.e., the fuel in the fuel tank 10). In the injector 20, a driving power for the fuel injection is transmitted through an oil pressure chamber Cd (i.e., a control chamber). As shown in FIG. 2, the injector 20 is structured as a fuel injection valve of a normally-closed type that is brought to a valve-closed state when de-energized.

The high-pressure fuel sent from the common rail 12 flows into a fuel inlet 22 formed in a housing 20e of the injector 20 and a part of the inflow high-pressure fuel flows into the oil pressure chamber Cd and the other part of the inflow high-pressure fuel flows toward injection holes 20f. A leak hole 24 is formed in the oil pressure chamber Cd and is opened and closed by a control valve 23. If the leak hole 24 is opened by the control valve 23, the fuel in the oil pressure chamber Cd is returned to the fuel tank 10 through the fuel discharge hole 21 from the leak hole 24.

When the fuel injection is performed with the injector 20, the control valve 23 is operated in accordance with an energization state (energization/de-energization) of a solenoid 20b constituting a two-way electromagnetic valve. Thus, a sealed degree of the oil pressure chamber Cd and eventually pressure in the oil pressure chamber Cd (equivalent to back pressure of a needle valve 20c) are increased/decreased. Due to the increase/decrease in the pressure, the needle valve 20c reciprocates (moves upward and downward) inside the housing 20e along with or against an extensional force of a spring 20d (a coil spring). Accordingly, a fuel supply passage 25 to the injection holes 20f (a necessary number of which are bored) is opened/closed at a halfway thereof (more specifically, at a tapered seat face, which the needle valve 20c is seated on and which the needle valve 20c is separated from in accordance with the reciprocating movement of the needle valve 20c).

Drive control of the needle valve 20c is performed through on-off control. That is, a pulse signal (an energization signal) directing ON/Off is sent from the ECU 30 to the drive section (the two-way electromagnetic valve) of the needle valve 20c. The needle valve 20c lifts and opens the injection holes 20f when the pulse is ON (or OFF), and the needle valve 20c descends to block the injection holes 20f when the pulse is OFF (or ON).

The pressure increase processing of the oil pressure chamber Cd is performed by the fuel supply from the common rail 12. Pressure reduction processing of the oil pressure chamber Cd is performed by operating the control valve 23 through the energization to the solenoid 20b and thus opening the leak hole 24. Thus, the fuel in the oil pressure chamber Cd is returned to the fuel tank 10 through the pipe 18 (shown in FIG. 1) connecting the injector 20 and the fuel tank 10. That is, the operation of the needle valve 20c that opens and closes the injection holes 20f is controlled by adjusting the fuel pressure in the oil pressure chamber Cd through the opening and closing operation of the control valve 23.

Thus, the injector 20 has the needle valve 20c that performs valve opening and valve closing of the injector 20 by opening and closing the fuel supply passage 25 extending to the injection holes 20f through a predetermined reciprocation action inside the valve body (i.e., the housing 20e). In a non-driven state, the needle valve 20c is displaced in a valve-closing direction by a force (the extensional force of the spring 20d) constantly applied to the needle valve 20c in the valve-closing direction. In a driven state, the needle valve 20c is applied with a driving force, so the needle valve 20c is displaced in a valve-opening direction against the extensional force of the spring 20d. The lift amount of the needle valve 20c changes substantially symmetrically between the non-driven state and the driven state.

The pressure sensor 20a (also refer to FIG. 1) for sensing the fuel pressure is fixed to the injector 20. The fuel inlet 22 formed in the housing 20e and the high-pressure pipe 14 are connected through a jig 20j, and the pressure sensor 20a is fixed to the jig 20j. Thus, by fixing the pressure sensor 20a to the fuel inlet 22 of the injector 20 in this way, fuel pressure (inlet pressure) at the fuel inlet 22 can be sensed at any time. More specifically, a fluctuation pattern of the fuel pressure accompanying an injection operation of the injector 20, a fuel pressure level (i.e., stable pressure), fuel injection pressure and the like can be sensed (measured) with the output of the pressure sensor 20a.

The pressure sensors 20a are provided to the multiple injectors 20(#1)-20(#4) respectively. The fluctuation pattern of the fuel pressure accompanying the injection operation of the injector 20 concerning a predetermined injection can be sensed with high accuracy based on the outputs of the fuel pressure sensors 20a (as mentioned in more detail later).

In addition to the above-described sensors, various sensors for vehicle control are provided in a vehicle (for example, a four-wheeled passenger car, a truck or the like, not shown). For example, a crank angle sensor 42 (for example, an electromagnetic pickup) that outputs a crank angle signal at every predetermined crank angle (for example, in a cycle of 30° C.A) is provided to an outer periphery of a crankshaft 41 as an output shaft of the target engine to sense a rotational angle position of the crankshaft 41, rotation speed of the crankshaft 41 (i.e., engine rotation speed NE), and the like. An accelerator sensor 44 that outputs an electrical signal corresponding to a state (i.e., a displacement amount) of an accelerator is provided to sense an operation amount ACCP (i.e., a pressed amount) of the accelerator by the driver.

In such the system, it is the ECU 30 that functions as the fuel injection controlling section according to the present embodiment and that mainly performs the engine control as the electronic control unit. The ECU 30 (an engine control ECU) has a well-known microcomputer (not shown). The ECU 30 grasps an operation state of the target engine and requests from the user based on the sensing signals of the above-described various types of sensors and operates the various types of actuators such as the suction control valve 11c and the injectors 20 in accordance with the engine operation state and the requests. Thus, the ECU 30 performs various kinds of control concerning the engine in the optimum modes corresponding to the situation of each time.

The microcomputer mounted in the ECU 30 consists of a CPU (a basic processing unit) for performing various kinds of computation, a RAM as a main memory for temporarily storing data in the progress of the computation, results of the computation and the like, a ROM as a program memory, an EEPROM as a data storage memory, a backup RAM (a memory invariably supplied with power from a backup power supply such as an in-vehicle battery even after a main power supply of the ECU 30 is stopped), and the like. Various kinds of programs, control maps and the like concerning the engine control including the program concerning the fuel injection control are beforehand stored in the ROM. The various kinds of control data including design data of the engine are beforehand stored in the data storage memory (for example, the EEPROM).

In the present embodiment, the ECU 30 calculates torque (request torque) that should be generated in the output shaft (the crankshaft 41) at the time and eventually a fuel injection quantity for satisfying the request torque based on the various kinds of the sequentially inputted sensor outputs (sensing signals). Thus, the ECU 30 variably sets the fuel injection quantity of the injector 20 to control the torque (the generation torque) generated through the fuel combustion in each cylinder (the combustion chamber) and eventually shaft torque (output torque) actually outputted to the output shaft (the crankshaft 41). That is, the ECU 30 controls the shaft torque to the request torque.

That is, for example, the ECU 30 calculates the fuel injection quantity corresponding to the engine operation state, the operation amount of the accelerator by the driver and the like at each time and outputs an injection control signal (a drive amount) for directing the fuel injection of the calculated fuel injection quantity to the injector 20 in synchronization with desired injection timing. Thus, i.e., based on the drive amount of the injector 20 (for example, a valve opening period), the output torque of the target engine is controlled to a target value.

As is well known, in the diesel engine, an intake throttle valve (a throttle) provided in an intake passage of the engine is held at a substantially fully-opened state during a steady operation for the purpose of increase in a fresh air quantity, reduction in a pumping loss and the like. Therefore, control of the fuel injection quantity is a main part of the combustion control during the steady operation (specifically, the combustion control concerning torque adjustment).

Hereafter a fundamental processing procedure of the fuel injection control according to the present embodiment will be explained with reference to FIG. 3. Values of various parameters used in the processing shown in FIG. 3 are stored at any time in the storage device mounted in the ECU 30 such as the RAM, the EEPROM or the backup RAM and are updated at any time when necessary. Fundamentally, a series of processing shown in FIG. 3 is serially performed at a frequency of one time per combustion cycle for each cylinder of the target engine through execution of the program stored in the ROM by the ECU 30. That is, with the program, fuel supply to all the cylinders except a dormant cylinder is performed during one combustion cycle.

As shown in FIG. 3, first in S11 (S means “Step”) in a series of the processing, predetermined parameters such as the current engine rotation speed (i.e., an actual measurement value measured by the crank angle sensor 42) and the fuel pressure (i.e., an actual measurement value measured by the pressure sensor 20a) are read and also the accelerator operation amount ACCP (i.e., an actual measurement value measured by the accelerator sensor 44) by the driver at the time and the like are read.

In following S12, an injection pattern is set based on the various parameters read in S11. For example, in the case of a single-stage injection, an injection quantity Q (an injection period) of the injection is variably set in accordance with the torque that should be generated in the output shaft (the crankshaft 41), i.e., the request torque that is calculated from the accelerator operation amount ACCP and the like and that is equivalent to the engine load at the time. In the case of an injection pattern of multi-stage injection, a total injection quantity Q (a total injection period) of the injections contributing to the torque is variably set in accordance with the torque that should be generated in the output shaft (the crankshaft 41), i.e., the request torque.

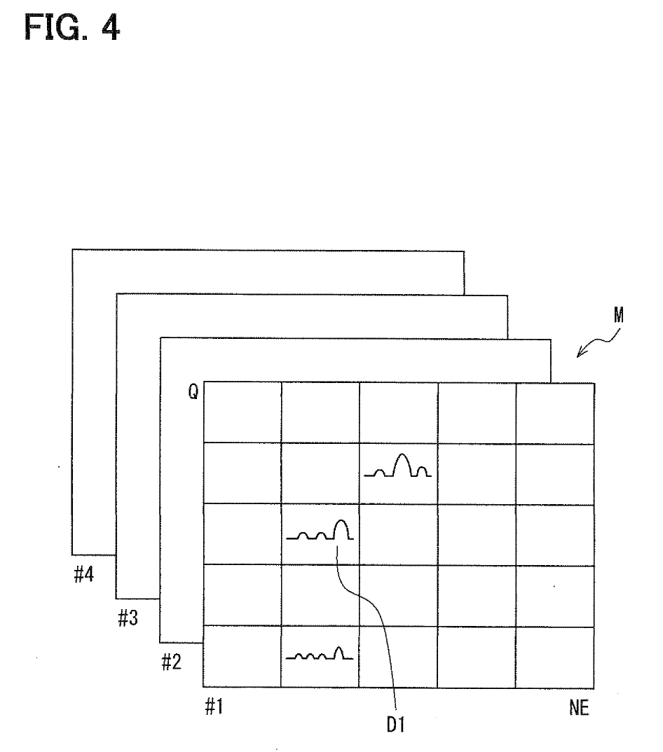

The injection pattern is obtained based on a map M (an injection control map or a mathematical expression) shown in FIG. 4 stored in the EEPROM, for example. The injection pattern is a pattern optimized to achieve the request torque and a suitable emission state. More specifically, the optimum injection pattern (adaptation values) is beforehand obtained by experiment and the like in anticipated ranges of the predetermined parameters (read in S11) and is written in the injection control map M, for example.

For example, the injection pattern is defined by parameters such as the number of injection stages (i.e., the time number of injections performed in one combustion cycle)₇ the injection timing of each injection (i.e., the injection timing) and the injection period (equivalent to the injection quantity) of each injection. The map M according to the present embodiment defines the relationship among the total injection quantity Q, the engine rotation speed NE, and the injection pattern. The map M is provided for each one of the injectors 20 of the respective cylinders #1-#4. The map M may be provided for each of other parameters such as engine coolant temperature.

A command value (a command signal) for the injector 20 is set based on the injection pattern obtained using the injection control map M. Thus, a pilot injection, a pre-injection, an after injection, a post-injection and the like are arbitrarily performed with a main injection in accordance with the situation of the vehicle and the like.

The thus set injection pattern or the eventual command value (the command signal) corresponding to the injection pattern are used in following S13. That is, in S13, the drive of the injector 20 is controlled based on the command value (the command signal), or more specifically, by outputting the command signal to the injector 20. After the drive control of the injector 20, the series of the processing shown in FIG. 3 is ended.

As mentioned above, a rate (a combustion rate) at which the actually injected fuel contributes to the combustion changes with various conditions such as a fuel property (for example, a cetane number). The injection patterns stored in the injection control map M are set through the experiment and the like before shipment of the injector 20 from the factory, assuming that the combustion rate is 80% at any total injection quantity Q or any engine rotation speed NE. Therefore, in the present embodiment, learning is performed by calculating the combustion rate in a state of a real car where the injector 20 is mounted in the engine (as described in more detail later) and changing and storing the data (the injection pattern) of the injection control map M based on the calculated combustion rate.

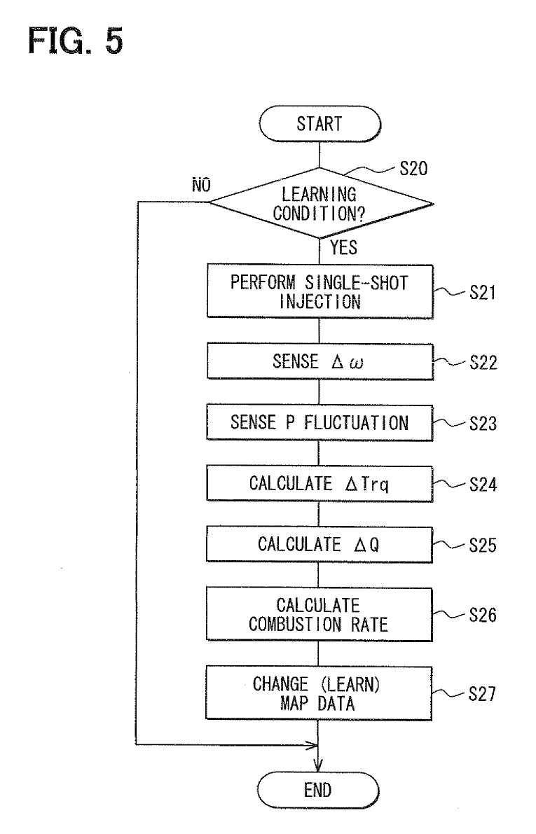

Hereafter, a processing procedure for calculating the actual combustion rate and a processing procedure for learning the map M will be explained with reference to FIG. 5. The ECU 30 repeatedly executes the processing of FIG. 5 in a predetermined cycle (for example, 4 msec) or at every specified crank angle, for example.

In a series of the processing, first in S20, it is determined whether a learning condition is satisfied. The learning condition includes a no-injection deceleration state where the accelerator is released and the vehicle is brought to a decelerating state, and fuel cut control is performed, for example. Alternatively the learning condition may be satisfied if the no-injection state occurs even if the deceleration state does not occur.

In following S21 (a torque increasing section), a single-stage injection (a single-shot injection) for opening and closing the injection holes 20f only once is performed by controlling the drive of the injector 20. That is, a single shot of a small injection for learning is performed by operating the injector 20, learning of which is desired. The small injection for the learning injects a predetermined small quantity of fuel. More specifically, a command injection period of the injector 20 is calculated from the fuel pressure sensed with the pressure sensor 20a and the small quantity (i.e., the small injection quantity for the learning), and opening operation of the injector 20 is performed in accordance with the command injection period.

The above-described small injection is an injection of a smaller quantity than a main injection mainly generating output torque demanded by the operation of the accelerator. The small injection is a pilot injection, a pre-injection, an after injection or the like performed before or after the main injection. The small injection quantity is set at 2 mm³/st in the present embodiment. Alternatively, two or more sorts of the small injection quantity may be set beforehand and the processing of following S22 to S27 may be performed for each of the multiple sorts of the small injection quantity.

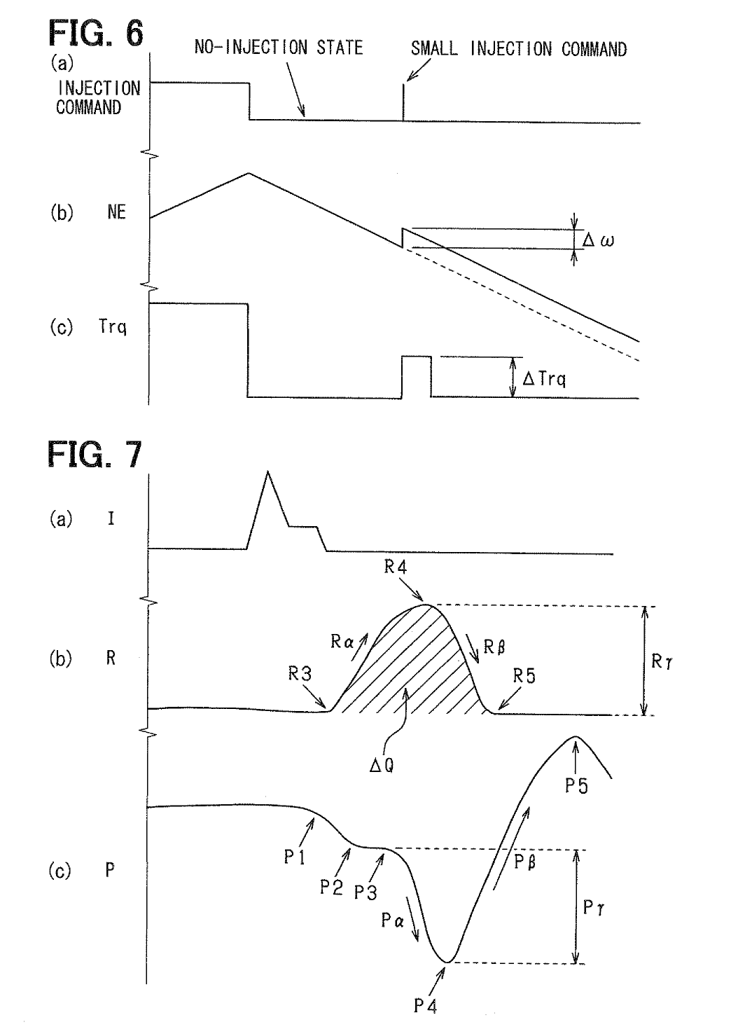

In following S22 (a torque increase amount sensing section), a rotation speed increase amount of the crankshaft 41 caused with combustion due to the small injection is sensed using the crank angle sensor 42 (a torque increase amount sensing section). For example, when the small injection by the injector 20(#1) of the first cylinder #1 is performed, the rotation speed at a certain timing in the case where the small injection is not performed is expressed as ω(i−1)+a×t, wherein ω(i−1) is the rotation speed at another timing (i−1) preceding the certain timing by 720° C.A, a is decreasing speed of the rotation speed at the another timing (i−1), and t is a time necessary for the rotation of 720° C.A to the small injection. Therefore, the rotation increase amount ΔΩ (refer to part (b) of FIG. 6) accompanying the small injection is calculated by a formula Δω=ω(i)−ω(i−1)−a×t, using the rotation speed ω(i) in the case of the small injection. Part (a) of FIG. 6 shows a pulse signal of the injection command and shows a state where the small injection command is outputted during the no-injection state. Part (b) of FIG. 6 shows change of the rotation speed NE caused in connection with the small injection, and part (c) of FIG. 6 is a timing chart showing change of the output torque Trq caused in connection with the small injection.

In following S23 (an injection quantity sensing section), fluctuation of the inlet pressure P caused in connection with the small injection (refer to part (c) of FIG. 7) is sensed with the pressure sensor 20a (an injection quantity sensing section). Part (a) of FIG. 7 shows change of driving current I to the solenoid 20b based on the small injection command. Part (b) of FIG. 7 shows change of a fuel injection rate R of the fuel from the injection holes 20f caused in connection with the small injection. Part (c) of FIG. 7 shows change of the sensing value (the inlet pressure P) of the pressure sensor 20a caused with the change of the injection rate R.

The sensing of the fuel pressure fluctuation in S23 is performed by subroutine processing separate from the processing of FIG. 5. It is desirable to serially acquire the sensor output of the pressure sensor 20a in the subroutine processing at an interval short enough to plot the profile of the pressure transition waveform with the sensor output. An example profile is illustrated in part (c) of FIG. 7. More specifically, the sensor output is serially acquired at an interval shorter than 50 microseconds (or more preferably, at an interval shorter than 20 microseconds).

In following S24, increase amount ΔTrq (refer to part (c) of FIG. 6) of the output torque actually caused in connection with the small injection is calculated based on the rotation increase amount Δw sensed in S22. For example, the increase amount ΔTrq of the output torque is calculated by a formula: ΔTrq=bΔω (b is a positive coefficient) or a map. The increase amount ΔTrq of the output torque may he calculated by performing correction based on parameters (for example, the engine coolant temperature) other than the rotation increase amount Δω.

In following S25, an injection quantity ΔQ of the fuel injected through the small injection is calculated based on the fluctuation of the inlet pressure P sensed in S23. For example, the change of the injection rate R shown in part (b) of FIG. 7 is estimated from the fluctuation of the inlet pressure P shown in part (c) of FIG. 7. Then, a shaded area in part (b) of FIG. 7 out of the estimated injection rate change is calculated as the injection quantity ΔQ. The change of the injection rate R can be estimated as mentioned above since there is a correlation between the fluctuation of the pressure (the inlet pressure P) sensed by the pressure sensor 20a and the change of the injection rate R as explained below.

That is, after the drive current I flows through the solenoid 20b as shown in part (a) of FIG. 7 and before the injection rate R starts rising at timing R3, the pressure P sensed by the pressure sensor 20a falls at a changing point P1. This is because the control valve 23 opens the leak hole 24 to perform the pressure reduction processing of the oil pressure chamber Cd at the timing P1. Then, the decrease from the changing point P1 stops at a changing point P2 when the oil pressure chamber Cd is sufficiently depressurized.

Then, as the injection rate R starts increasing at the timing R3, the sensed pressure P starts decreasing at a changing point P3. Then, as the injection rate R reaches the maximum injection rate at timing R4, the decrease of the sensed pressure P stops at a changing point P4. The decrease from the changing point P3 to the changing point P4 is larger than the decrease from the changing point P1 to the changing point P2.

Then, as the injection rate R starts decreasing at the timing R4, the sensed pressure P starts increasing at the changing point P4. Then, as the injection rate R becomes zero and the actual injection ends at timing R5, the increase of the sensed pressure P stops at a changing point P5. The sensed pressure P after the changing point P5 attenuates while repeating decrease and increase in a fixed cycle (not illustrated).

Thus, the increase start timing R3 (the injection start timing) and the decrease end timing R5 (the injection end timing) of the injection rate R can be estimated by detecting the changing points P3 and P5 in the fluctuation of the sensed pressure P sensed by the pressure sensor 20a. Moreover, the change of the injection rate R can be estimated from the fluctuation of the sensed pressure P based on the correlation between the fluctuation of the sensed pressure P and the change of the injection rate R as explained below.

That is, there is a correlation between a pressure decrease rate Pα from the changing point P3 to the changing point P4 of the sensed pressure P and an injection rate increase rate Rα from the changing point R3 to the changing point R4 of the injection rate R. There is a correlation between a pressure increase rate Pβ from the changing point P4 to the changing point P5 and an injection rate decrease rate Rα from the changing point R4 to the changing point R5. There is a correlation between a pressure decrease amount Pγ from the changing point P3 to the changing point P4 and an injection rate increase amount Rγ from the changing point R3 to the changing point R4. Accordingly, the injection rate increase rate Rα, the injection rate decrease rate Rβ, and the injection rate increase amount Rγ of the injection rate R can be estimated by sensing the pressure decrease rate Pα, the pressure increase rate Pβ, and the pressure decrease amount Pγ from the fluctuation of the sensed pressure P sensed by the pressure sensor 20a. As described above, the various states R3, R5, Rα, Rβ, and Rγ of the injection rate R can be estimated, and eventually, the actual injection quantity ΔQ as the area of the shaded portion shown in part (b) of FIG. 7 can be calculated.

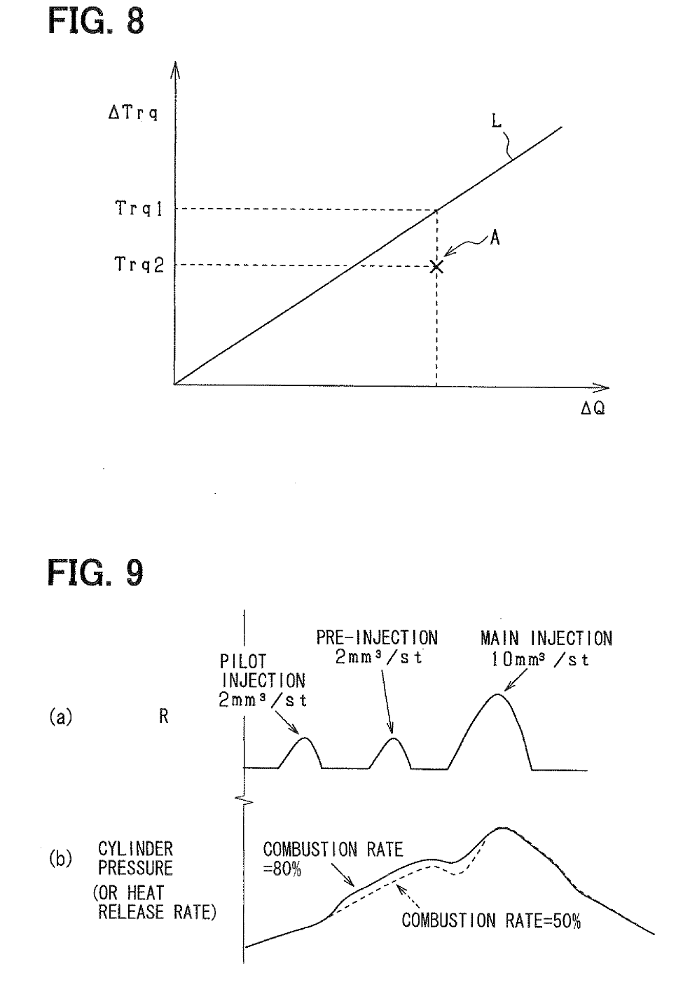

A solid line L in FIG. 8 shows a relationship between the output torque ΔTrq and the injection quantity ΔQ when all the fuel injected through the small injection contributes to the combustion (i.e., in the case where the combustion rate is 100%). Since the combustion rate is lower than 100% in the actual combustion, a point (for example, a point A in FIG. 8) showing the relationship between the output torque ΔTrq and the injection quantity ΔQ calculated in S24 and S25 exists in an area lower than the solid line L in FIG. 8. That is, even if the injection quantity ΔQ is the same, the obtained output torque decreases as the combustion rate decreases.

In view of this point, in following S26 (a combustion rate calculating section), the combustion rate is calculated by comparing the actual output torque increase amount ΔTrq calculated in S24 and the actual injection quantity ΔQ calculated in S25. For example, output torque Trq1 is obtained by assigning the value of the injection quantity ΔQ calculated in S25 to a relational expression of the solid line L and is compared with output torque Trq2 (i.e., the increase amount ΔTrq) calculated in S24. Thus, a deficiency Trqα of the output torque Trq2 with respect to the output torque Trq1 is calculated. Then, the combustion rate is calculated by a formula: combustion rate=1−Trqα×c (c is a positive coefficient).

In following S27, learning is performed by changing and storing the data (the injection pattern) stored in the map M described above and shown in FIG. 4 based on the combustion rate calculated in S26. More specifically, the data in the map M corresponding to the various conditions at the time when the small injection is performed (for example, the engine rotation speed NE, the small injection quantity ΔQ, the number (#1-#4) of the injector 20 and environmental conditions such as the engine coolant temperature), i.e., the injection pattern (the number of injection stages, injection timing and injection quantity of each of the injections, and the like), is changed to achieve desired output torque and emission state.

For example, change of the data indicated by a mark D1 in FIG. 4 will be explained below with reference to FIG. 9. According to the injection pattern of the data D1 (refer to part (a) of FIG. 9), the data D1 is produced on an assumption that the cylinder pressure (or the heat release rate) changes as shown by a solid line in part (b) of FIG. 9 in the case where the combustion rate is 80%. If the cylinder pressure changes exactly as assumed, the desired output torque and emission state can be achieved. However, when the combustion rate calculated in S26 is 50%, it is anticipated that the cylinder pressure (or the heat release rate) actually changes as shown by a broken line in part (b) of FIG. 9 even if the injection in the injection pattern D1 is performed. Therefore, the injection pattern D1 is changed to change an injection mode, thereby changing the behavior shown by the broken line in part (b) of FIG. 9 to the behavior shown by the solid line.

As shown in part (b) of FIG. 9, when the combustion rate is less than the originally assumed desired rate (80%), the data D1 may be changed as follows, for example. Following example schemes may be combined arbitrarily.

(i) The data D1 is changed so that the pilot injection quantity increases from 2 mm³/st to 3 mm³/st. In this case, in order to prevent the change in the total injection quantity, the data D1 should be preferably changed so that the main injection quantity is reduced by the increase (1 mm³/st) in the pilot injection quantity.

(ii) The data D1 is changed so that the pilot injection timing advances.

(iii) The data D1 is changed so that the main injection timing advances.

(iv) The data D1 is changed so that the number of stages of the pilot injection is increased from one to two. In this case, in order to prevent the change in the total injection quantity, the data D1 should be preferably changed so that the main injection quantity is reduced by the increase (2 mm³/st) in the pilot injection quantity.

In the case where the combustion rate is higher than the desired combustion rate (80%) that is originally assumed, change contrary to the above change may be performed. That is, at least one of decreasing adjustment of the pilot injection quantity, delaying adjustment of the pilot injection timing, delaying adjustment of the main injection timing, and decreasing adjustment of the pilot injection stage number may be performed.

Thus, if the processing in S27 is completed, a series of processing shown in FIG. 5 is ended once. It is preferable to set multiple types of small injections in S21 (for example, small injections of 1 mm³/st, 2 mm³/st, 3 mm³/st, 4 mm³/st and 5 mm³/st) and to execute the processing of S22 to S27 for each of the small injection quantities. Thus, the number of the learned data out of the multiple data stored in the map M can be increased.

It is preferable to store parameters such as the pressure P sensed by the pressure sensor 20a, the engine rotation speed NE, and the cylinder number #1-#4 at the time when performing the small injection in S21 while relating the parameters to the calculated combustion rate and to learn the data corresponding to the parameters among the multiple data stored in the map M.

The present embodiment described above exerts following outstanding effects.

(1) The rotation increase amount Δω caused in connection with the small injection is calculated based on the sensing value of the crank angle sensor 42 (S22), and the actual torque increase amount ΔTrq is calculated based on the calculated rotation increase amount Δω (S24). The fuel pressure fluctuation caused in connection with the small injection is sensed with the pressure sensor 20a (S23), and the actual injection quantity ΔQ is calculated based on the sensed fuel pressure fluctuation (S25). Then, the combustion rate is calculated by comparing the actual torque increase amount ΔTrq and the actual injection quantity ΔQ (S26), and the data (the injection pattern) of the injection control map M is changed in accordance with the combustion rate to achieve the desired output torque and emission state. Accordingly, the fuel injection control can be performed with high accuracy such that the desired output torque and emission state are achieved.

(2) If the combustion rate calculated by the processing of FIG. 5 is lower than the desired rate when the data of the map M is changed, the data of the map M is changed to increase the pilot injection quantity. Thus, ignitability of the fuel injected through the pilot injection can be improved, so the combustion rate can be approximated to the desired combustion rate. When the combustion rate is high, the data is changed to reduce the pilot injection quantity, thereby reducing the emission (for example, HC and CO). Thus, the output torque and the emission state can be adjusted to the desired states by adjusting the pilot injection quantity in accordance with the calculated combustion rate.

(3) When the data of the map M is changed to adjust the pilot injection quantity, in order to prevent the change of the total injection quantity, the data is changed so that the main injection quantity is decreased (or increased) by the increase (or the decrease) in the pilot injection quantity. Thus, the increase/decrease adjustment of the pilot injection quantity is performed to adjust the ignitability and the emission while performing the adjustment to prevent the increase/decrease in the total quantity of the fuel injected per combustion cycle. Thus, the adjustment can be performed such that the torque acquired per combustion cycle does not become excessively larger or smaller than the desired torque.

(4) The data of the map M is changed to change the injection timing of the main injection in accordance with the combustion rate. Therefore, the adjustment can be easily performed to inhibit the delay (or advance) of the peak timing of the cylinder pressure or the ignition timing of the main injection from the desired timing due to the low (or high) combustion rate.

(5) When the combustion rate is low (or high), the pilot injection quantity is increased (or decreased) to inhibit the delay (or the advance) of the peak timing of the cylinder pressure or the ignition timing of the main injection. Furthermore, in the present embodiment, when the combustion rate is low (or high) to an extent that the state cannot be handled only with the pilot injection quantity, the main injection timing is advanced (or delayed) in addition to the increase (or the decrease) of the pilot injection quantity. Accordingly, the delay (or the advance) of the peak timing or the ignition timing described above can be further inhibited.

(6) In the present embodiment, the combustion rate calculated by the processing of FIG. 5 is stored in the EEPROM or the like while the combustion rate is related to the various conditions at the time when the small injection is performed (i.e., the engine rotation speed NE, the small injection quantity ΔQ, the number (#1-#4) of the injector 20, and the environmental conditions such as the engine coolant temperature). The data in the map M corresponding to the parameters is changed to achieve the desired output torque and emission state. The combustion rate varies with each of the above-described parameters. Therefore, according to the present embodiment that calculates the combustion rate and changes the data for each one of the parameters affecting the combustion rate, the output torque and the emission state of the engine can be controlled with higher accuracy.

(7) The pressure sensor 20a is arranged to be closer to the injection holes 20f than the common rail 12. Accordingly, the fuel pressure fluctuation changing in connection with the small injection from the injection holes 20f can be sensed with high accuracy, Therefore, the change of the injection rate can be calculated with high accuracy from the sensed fuel pressure fluctuation and eventually the actual injection quantity ΔQ of the small injection can be calculated with high accuracy. Therefore, the data of the map M can be changed to the optimum values with high accuracy.

Moreover, in the present embodiment, the pressure sensor 20a is fixed to the injector 20. Therefore, the mounting location of the pressure sensor 20a is closer to the injection holes 20f than in the case where the pressure sensor 20a is fixed to the high-pressure pipe 14 connecting the common rail 12 with the injector 20. Accordingly, the pressure fluctuation at the injection holes 20f can be sensed more appropriately than in the case where the pressure fluctuation is sensed after the pressure fluctuation in the injection holes 20f attenuates in the high-pressure pipe 14.

The present invention is not limited to the above-described embodiment but may be implemented as an arbitrary combination of the characteristic structures according to the above-described embodiment. Moreover, the present invention may be implemented as follows, for example.

The ECU 30 may calculate the cetane number of the fuel based on the combustion rate calculated by the processing of FIG. 5. More specifically, as described above with reference to FIG. 8, the output torque Trq1, which is obtained from the relational expression of the solid line L, may be compared with output torque Trq2 (i.e., the increase amount ΔTrq) calculated in S24, and a deficiency Trq3 of the output torque Trq2 with respect to the output torque Trq1 may be calculated. Then, the cetane number may be calculated based on the value of the deficiency Trq3. For example, the cetane number may be calculated based on a computation formula: cetane number =Trq3×d+e (d is a negative coefficient and e is a positive constant) or a map.

In the above-described embodiment, the data of the map M of FIG. 4 is changed using the combustion rate calculated by the processing of FIG. 5 as it is. Alternatively, the small injection may be performed multiple times under the same conditions such as the engine rotation speed NE and integral averaging of the values of the combustion rate calculated for the respective small injections may be performed. Then, the data of the map M of FIG. 4 may be changed using a combustion rate obtained through the integral averaging. In this case, the influence of the sensing error concerning the torque increase amount sensing in S22 and the injection quantity sensing in S23 can be lessened compared with the case where the data of the map M is changed using the calculation result of the combustion rate obtained through one time of the fuel injection as it is. As a result, the map M containing little influence of the sensing error can be obtained.

When the injection pattern is set in S12 of FIG. 3, the map M of FIG. 4 stored in the EEPROM is used in the above-described embodiment. Alternatively, a mathematical expression may be stored and held in the EEPROM in place of the map M and the injection pattern may be calculated and set by assigning the parameters acquired in S11 to the mathematical expression. More specifically, the above mathematical expression may be set for each of the various status values for specifying the injection pattern (for example, such as the injection stage number the injection start timing R3, the injection end timing R5, the injection rate increase rate Rα, the injection rate decrease rate Rβ and the injection rate increase amount Rγ of each injection stage, and the like). In this case, correction coefficients in the mathematical expression may be changed in accordance with the combustion rate.

In the above-described embodiment, the learning control for changing the map M or the mathematical expression in accordance with the combustion rate calculated by the processing of FIG. 5 is performed. Alternatively, in place of such the learning control, feedback control may be performed as illustrated below. For example, a target value of the combustion rate may be calculated based on the various parameters acquired in S11 of FIG. 3 and an injection pattern achieving the target value may be decided. Then, feedback control may be performed to correct the injection pattern such that the combustion rate calculated by the processing of FIG. 5 approximates to the target value.

In place of the electromagnetic drive injector 20 shown in FIG. 2, a piezo drive injector may be used. Alternatively, an injector that does not cause pressure leak from the leak hole 24 and the like such as a direct acting injector that transmits the drive power not through the oil pressure chamber Cd (for example, a direct acting piezo injector under development in recent years) can be also used. In the case where the direct acting injector is used, control of the injection rate is facilitated.

In the above-described embodiment, the pressure sensor 20a is fixed to the fuel inlet 22 of the injector 20. Alternatively, as shown by a chained line 200a in FIG. 2, a pressure sensor 200a may be mounted inside the housing 20e to sense fuel pressure in the internal fuel passage 25 extending from the fuel inlet 22 to the injection holes 20f.

The fixing structure of the pressure sensor 20a can be simplified in the case where the pressure sensor 20a is fixed to the fuel inlet 22 as compared with the case where the pressure sensor 200a is mounted inside the housing 20e. When the pressure sensor 200a is mounted inside the housing 20e, the fixing point of the pressure sensor 200a is closer to the injection holes 20f than in the case where the pressure sensor 20a is fixed to the fuel inlet 22. Therefore, the pressure fluctuation in the injection holes 20f can be sensed more precisely when the pressure sensor 200a is mounted inside the housing 20e.

The pressure sensor 20a may be fixed to the high-pressure pipe 14. In this case, it is preferable to fix the pressure sensor 20a to a position distanced from the common rail 12 by a predetermined distance.

A flow rate restricting section may be provided between the common rail 12 and the high-pressure pipe 14 for restricting a flow rate of the fuel flowing from the common rail 12 to the high-pressure pipe 14. The flow rate restricting section functions to block the flow passage when an excessive fuel outflow is generated by fuel leakage due to a damage to the high-pressure pipe 14, the injector 20 and the like. For example, the flow rate restricting section may be constituted of a valve member such as a ball that blocks the flow passage when the excessive flow rate occurs. Alternatively, a flow damper constituted by integrally combining the orifice 12a (the fuel pulsation reducing section) and the flow rate restricting section may be adopted.

In place of the construction of arranging the pressure sensor 20a downstream of the orifice and the flow rate restricting section with respect to the fuel flow direction, the pressure sensor 20a may be arranged downstream of at least one of the orifice and the flow rate restricting section.

An arbitrary number of the fuel pressure sensor(s) 20a may be used. For example, two or more sensors 20a may be provided to the fuel flow passage of one cylinder. A rail pressure sensor for sensing the pressure in the common rail 12 may be provided in addition to the above-described fuel pressure sensor 20a.

The kind and the system configuration of the engine as the control target may also be arbitrarily modified in accordance with the use and the like. In the above-described embodiment, the present invention is applied to the diesel engine as an example. For example, the present invention can also be applied to a spark ignition gasoline engine (specifically, a direct-injection engine) or the like basically in the similar way. For example, a fuel injection system of a direct-injection gasoline engine generally has a delivery pipe that stores fuel (gasoline) in a high-pressure state. In the system, the fuel is pumped from a fuel pump to the delivery pipe. The high-pressure fuel in the delivery pipe is distributed to the multiple injectors 20 and injected and supplied into engine combustion chambers. In this system, the delivery pipe corresponds to the pressure accumulator. The device and the system according to the present invention is applied not only to the injector that injects the fuel directly into the cylinder but also to an injector that injects the fuel to an intake passage or an exhaust passage of the engine.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A control device of an internal combustion engine, the control device comprising:
a torque increasing means for performing fuel injection by operating an injector of the internal combustion engine, thereby increasing output torque of the internal combustion engine;
a torque increase amount sensing means for sensing an increase amount of the output torque caused in connection with the fuel injection or a physical quantity relevant to the increase amount;
an injection quantity sensing means for sensing an actual injection quantity of the fuel injection or a physical quantity relevant to the injection quantity;
a combustion rate calculating means for calculating a combustion rate based on a sensing value of the torque increase amount sensing means and a sensing value of the injection quantity sensing means, the combustion rate indicating a rate at which the fuel injected through the fuel injection contributes to combustion; and
a controlling means for controlling an operation state of the internal combustion engine in accordance with the combustion rate calculated by the combustion rate calculating means.

2. The control device as in claim 1, wherein
the internal combustion engine has a fuel supply system that distributes and supplies the fuel from a pressure accumulator accumulating the fuel to the injector, and
the injection quantity sensing means is a fuel pressure sensor that senses pressure of the fuel supplied to the injector as the physical quantity and that is located in a fuel passage extending from the pressure accumulator to an injection hole of the injector at a position closer to the injection hole than the pressure accumulator.

3. The control device as in claim 1, wherein
the torque increase amount sensing means is a rotation speed sensor that senses rotation speed of an output shaft of the internal combustion engine as the physical quantity.

4. The control device as in claim 1, wherein
the controlling means is an injection controlling means for controlling an operation of the injector to change an injection mode of the fuel in accordance with the combustion rate.

5. The control device as in claim 4, wherein
the injection controlling means is configured to be able to execute control of multi-stage injection for injecting the fuel multiple times during one combustion cycle, and
the injection controlling means changes the injection mode by changing at least one of the number of injection stages in the multi-stage injection, an injection quantity of each injection stage of the multi-stage injection, and injection timing of each injection stage of the multi-stage injection.

6. The control device as in claim 5, wherein
the injection controlling means changes the injection mode to change an injection quantity of a pilot injection in the multi-stage injection in accordance with the combustion rate.

7. The control device as in claim 6, wherein
the injection controlling means changes the injection mode to decrease an injection quantity of a main injection when the injection controlling means increases the injection quantity of the pilot injection, and
the injection controlling means changes the injection mode to increase the injection quantity of the main injection when the injection controlling means decreases the injection quantity of the pilot injection.

8. The control device as in claim 5, wherein
the injection controlling means changes the injection mode to change injection timing of a main injection in the multi-stage injection in accordance with the combustion rate.

9. The control device as in claim 1, wherein
the torque increasing means executes the fuel injection multiple times under the same condition,
the combustion rate calculating means performs integral averaging of multiple calculation results of the combustion rate obtained through the multiple times of the fuel injection, and
the controlling means controls the operation state of the internal combustion engine in accordance with a combustion rate obtained through the integral averaging.

10. The control device as in claim 1, wherein
the controlling means employs at least one of pressure of the fuel supplied to the injector, rotation speed of an output shaft of the internal combustion engine and the number of a cylinder of the internal combustion engine as a parameter or parameters and stores the combustion rate in relation to each parameter, and
the controlling means controls the operation state of the internal combustion engine in accordance with the combustion rate corresponding to each parameter.

11. The control device as in claim 1, further comprising:
a cetane number estimating means for estimating a cetane number of the fuel based on the combustion rate calculated by the combustion rate calculating means.
